(19) United States
(12) Patent Application Publication
(10) Pub. No.: US 2006/0017959 A1
(43) Pub. Date: Jan. 26, 2006

(54) Document classification and authentication

(76) Inventors: Raymond J. Downer, Bedford, NH (US); Claudio DeMarco, Manchester, NH (US); Dennis Kallelis, Middleton, MA (US); Robert Orenberg, Hollis, NH (US); Jeffrey Setrin, Merrimack, NH (US); Jiangsheng You, Auburndale, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/176,780

(22) Filed: Jul. 6, 2005

Related U.S. Application Data
(60) Provisional application No. 60/585,628, filed on Jul. 6, 2004.

(51) Int. Cl. G06K 15/00

(52) U.S. Cl. 358/1.14; 382/139

(57) ABSTRACT

Apparatus and a method are disclosed for reading documents, such as identity documents including passports, and documents of value, to obtain image sets of the documents, to determine a document form factor, to read and/or detect security information with an illumination device to classify the documents and determine if the documents are counterfeit or have been altered. The apparatus and method also include network capabilities to transfer document information between a network database and document reading devices.

### CROSS-REFERENCE TO RELATED ACTIONS

This application claims the benefit of U.S. Provisional Application No. 60/585,628, filed Jul. 6, 2004 that is incorporated herein by reference.

### BACKGROUND

Illegal modifications and counterfeiting of identification documents, such as passports, drivers licenses, and identification cards and badges, and documents of value, such as bonds, certificates, and negotiable instruments, has been increasing year by year to the concern of companies, governments, and the agencies that issue these documents. To counter this problem, new materials and new techniques have been and are being developed for the production of such identity documents and documents of value that will make it more and more difficult to alter or counterfeit the documents, and faster and easier to detect if such documents are counterfeit or have been altered.

These new materials may utilize new laminating schemes and materials that make use of holograms; invisible inks that only appear when illuminated by certain wavelengths of visible or invisible light; retro-reflective layers inside the laminating materials; different types of inks that have one color under normal ambient light but show up as different colors when illuminated by certain wavelengths of invisible light, and many other schemes. In addition, magnetic and radio frequency (RF) taggants may be added to the laminates or base materials of documents during their manufacture, and such taggants may be detected while being invisible to the eye. Further, new techniques, such as micro-miniature smart chips, magnetic stripes, optical stripes, and one-dimensional and two-dimensional bar codes may be embedded in such documents and used in reading and verifying documents such as listed above. In addition, the International Civil Aviation Organization (ICAO) has developed standards for Machine Readable Travel Documents (MRTDs), including passports and visas. The MRTD standards enable improvements in the accuracy of automated document review systems.

Prior art systems provide apparatus and methods to read, classify and authenticate documents, such as the apparatus and methods disclosed in U.S. Pat. No. 6,269,169 B1 and U.S. Pat. No. 6,088,133, whereby documents are read to obtain and verify information recorded thereon to determine if such documents are counterfeit or have been altered. As the volume and diversity of document types increases, improvements in the ability to classify and authenticate documents are required.

### SUMMARY

In general, in an aspect, the invention provides a method for classifying and authenticating a document, the method including capturing a first image set of the document, attempting to determine a document type by comparing a first attribute of the image set to a second attribute stored in a first list of attributes for a group of different document types, searching for a first machine readable zone on the document based on the document type, determining a first value based on the first machine readable zone, attempting to identify a document class for the document using the first value, and initiating an authentication procedure for the identified document class.

Implementations of the invention may include one or more of the following features. The first image set includes illuminating the document with a first illumination source, and capturing a second image set by illuminating the document with the a second illumination source. The first and second illumination sources have different characteristics. The method also includes searching for a second machine readable zone on the document using the second image set. The second image set may occur if the first value is undetermined. The method may include capturing a third image set of the document by illuminating the document with a third illumination source. The characteristics of the third illumination source are different from the characteristics of the first and second illumination sources, and the method further includes searching for a third machine readable zone on the document using the third image set.

Also, implementations of the invention may include one or more of the following features. The attempting to determine the document type includes calculating a confidence factor. The confidence factor is based on the first attribute of the first image set and the second attribute stored in a particular one of the first lists of attributes, comparing the confidence factor to a threshold confidence, and identifying a first document type associated with the particular one of the first lists of attributes if the confidence factor is greater than the threshold confidence, where the first document type is included in the group of different document types.

Also, implementations of the invention may include one or more of the following features. Capturing a second image set of the document. Displaying a list of document types to an operator, and accepting an input from the operator, where the input is indicative of a second document type, where the second document type is included in the list of document types.

Also, implementations of the invention may include one or more of the following features. The attempting to identify the document class includes comparing the first attribute of the image set to a group of attributes associated with a collection of different document classes; and selecting the document class from the collection different document classes if the first attribute of the image set corresponds to a particular attribute associated with the document class. The method further includes searching sequentially from an attribute corresponding to a most frequently occurring document class to an attribute corresponding to a least frequently occurring document class. The method also includes attempting to identify a document subclass by comparing the attribute of the image set to a group of attributes associated with a collection of different document subclasses, where the collection of different document subclasses is associated with the document class, and selecting the document subclass from the collection of different document classes if the attribute of the image set corresponds to a particular attribute associated with the document subclass. Also, attempting to identify a document by subclass includes comparing the first value to at least one of a respective group of attributes associated with a collection of different document subclasses, where the collection of different document subclasses is associated with the document class, and selecting a document subclass from the collection of different document subclasses if the first value corresponds to a particular attribute associated with the document subclass.

Also, implementations of the invention may include one or more of the following features. The attempting to identify the document class includes searching the document for a machine detectable device including a magnetic stripe, a smart-chip, and an optical bar code, evaluating the machine detectable device for a second value, and selecting the document class for the document using the second value.

In general, in another aspect, the invention provides a computer program product for use with a document classification and authentication device, the computer program product residing on a computer-readable medium and comprising computer-readable instructions configured to cause a computer to store an image set of a document, determine a form factor of the image set, search for at least one machine readable zone in the image set based on the form factor, classify the document using the machine readable zone, and authenticate the document using a document class of the document. The instructions are also configured to cause the computer to store an image set of the document cause the computer to activate a first illumination source. The computer program product instructions configured to cause the computer to store an image set of a document are also configured to cause the computer to activate the first illumination source and a second illumination source, where the first and second illumination sources have different illumination characteristics.

Also, implementations of the invention may include one or more of the following features. The computer program product instructions configured to cause the computer to determine a form factor are also configured to cause the computer to compare at least one attribute of the image set to at least one attribute associated with a group of different document types. The instructions may also cause the computer to do any or all of the following: access the attributes through a network port, display a list of form factors to an operator, activate a third illumination source, where the third illumination source has third set of illumination characteristics, interpret the at least one machine readable zone for a first value, determine a first document class using the first value, and/or determine a second document class using the first value and the first document class.

Also, implementations of the invention may include one or more of the following features. The computer program product instructions configured to cause the computer to search for at least one machine readable zone are also configured to cause the computer to interpret a machine detectable device for a second value, where the machine detectable device is at least one of a magnetic stripe, a smart-chip, and an optical bar code. The instructions are also configured to cause the computer to determine a second document class using the second value. Further, the instructions are also configured to cause the computer to determine a third document class using the second data value and the second document class.

In general, in another aspect, the invention provides a system for classifying and authenticating a document, the system including illumination sources, means for storing a digital image of the document illuminated by at least one of the illumination sources, for computing document attributes from the digital image. The system also provides means for connecting to at least one database containing document form factor records, for searching the at least one database for a first data field in the document form factor records, and for identifying a first document form factor based on a correlation between the first data field and a particular attribute in the document attributes. The system also provides means for interpreting the first document form factor to determine the location and content of at least one machine readable zone, for searching the at least one database for a second data field in a collection of document class records, and for selecting a first document class associated with a particular document class record based on a correlation between the content of the at least one machine readable zone and the second data field, and means for initiating an authentication procedure based on the first document class.

Also, implementations of the invention may include one or more of the following features. The system may also provide means for selecting one or more of the illumination sources based on the document form factor, to sort and search the collection of document classes in order of a frequency of occurrence, where the frequency of occurrence is based on the number of times a particular document class is accessed over a period of time, and for searching the at least one database for a third data field in the collection of document class records, and for selecting a second document class associated with a particular document class record based on a correlation between at least one of the plurality of document attributes from the digital image and the third data field.

In accordance with implementations of the invention, one or more of the following capabilities may be provided. A broader array of existing document formats can be classified and authenticated. New document types, data devices, and biometric information can be accommodated. Multiple documents can be classified and authenticated simultaneously. Document classification and authentication response time can be reduced and document throughput can be increased. Document data can be shared across local and wide area networks. Processing capabilities can be shared and installation costs can be reduced. Classification and authentication processes and network configurations can be customized for various applications.

These and other capabilities of the invention, along with the invention itself, will be more fully understood after a review of the following figures, detailed description, and claims.

### BRIEF DESCRIPTION OF THE FIGURES

FIG. 1 is a functional block diagram of a document reader-verifier.

FIG. 2 is a functional block diagram depicting a process to illuminate a document.

FIG. 3 is a block flow diagram of a process to classify and authenticate a document.

FIG. 4 is a block flow diagram of a process to confirm a form factor for a document.

FIG. 5 is a block flow diagram of a process to determine data fields from a Machine Readable Zone (MRZ).

FIG. 6 is a block flow diagram of a process to return a document classification when MRZ fields are, or are not, detected.

FIG. 7 is a block flow diagram of a process to return a jurisdiction model.

FIG. 8 is a block diagram of networked reader-verifier installation.

### DETAILED DESCRIPTION OF PREFERRED EMBODIMENTS

The present invention provides improvements to apparatus and methods disclosed and claimed in U.S. Pat. No. 6,269,169 B1 and U.S. Pat. No. 6,088,133, which are incorporated herein in their entirety by reference and are assigned to the assignee of the present application.

Embodiments of the invention provide techniques for classifying and authenticating documents. For example, a document scanning device includes optical illumination sources, optical recorders, a processor, memory devices, display systems, and communication ports. A document is scanned with a first illumination source to produce an image set. The image set is stored in memory. The processor determines a form factor for the image set. The form factor has an associated confidence factor. If the confidence factor does not meet a required confidence threshold, the processor produces a list of reference images that are similar to the form factor and alerts an operator that the document is potentially not authentic. The operator can select a reference image from the list of reference images. The operator may also choose to scan the document again with the same illumination source.

The processor detects for at least one Machine Readable Zone (MRZ) in the image based on the form factor. If the MRZ is detected, the data fields associated with the MRZ are stored in memory. If an MRZ is not detected, the operator is alerted and the document is scanned with a second illumination source to produce a second image set. The second image set is stored in memory. The processor detects at least one MRZ in the second image set on the form factor. If an MRZ is detected in the second image set, the data fields associated with the MRZ are stored in memory. If an MRZ is not detected in the second image set, the system can optionally search the document for other optical or electronic data components (e.g. magnetic stripe, barcode data, and embedded smart chips).

A collection of jurisdiction models persist in memory. Each jurisdiction model includes at least one form factor attribute. The processor determines a jurisdiction model from the MRZ data fields. If the document does not have an MRZ, or the MRZ data fields do not correlate to a jurisdiction model, the processor compares the form factor of the scanned image with a sorted list of jurisdiction model form factor attributes. The list of jurisdiction model, with corresponding form factor attributes, is sorted based on frequency of occurrence of the models. The scanned image is compared to the jurisdiction models with the highest frequency of occurrence first. If a match between the scanned image and jurisdiction model is not determined, the processor generates an unknown document event and alerts the operator. If a match between the scanned image and the jurisdiction model is identified, a jurisdiction model identifier is stored in memory.

A collection of series models persist in memory. A series model includes a subtype and at least one series classification attribute. The series models may correlate to MRZ data fields and/or to jurisdiction model identifiers. The processor selects a series model based on the MRZ data fields and/or jurisdiction model identifiers. If a series model is selected, a classification result is stored in memory and a document authentication process is initiated. If a series model is not selected, the processor may search at least one model sub-directory. If a series model is selected during the search of the at least one model sub-directory, a classification result is stored in memory. If a series model is not selected, the processor alerts the operator. Other embodiments are also within the scope of the invention.

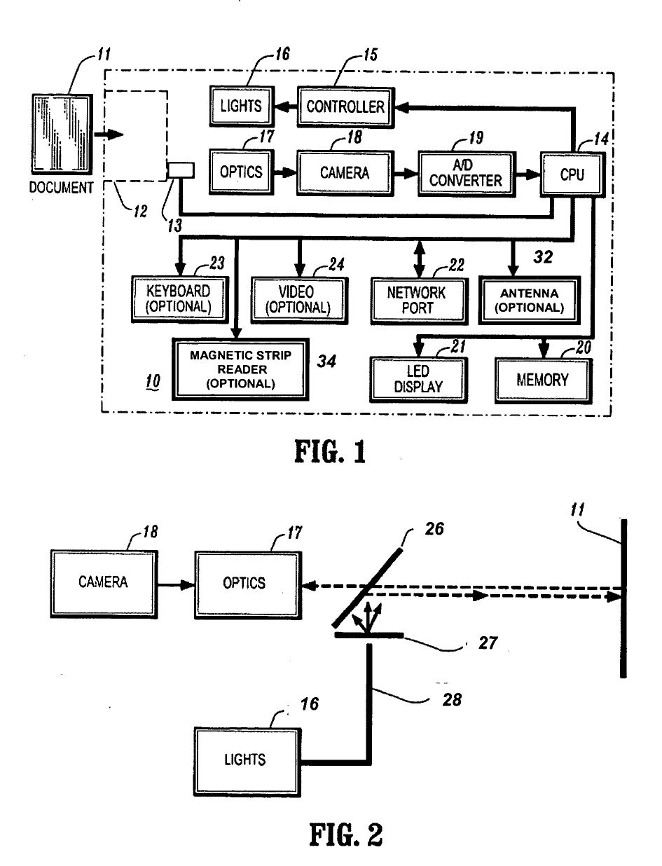

Referring to FIG. 1, a document reader-verifier 10 includes a slot or opening 12 configured to receive a document 11, a switch 13, a processor 14, a controller 15, an illumination device 16 that includes at least one illumination source, optics 17, a camera 18, an A/D converter 19, a memory device 20, an LED display 21, and at least one network port 22. The document reader-verifier 10 may also optionally include a video display 24, a keyboard 23, a smart-chip antenna 32, and a magnetic stripe reader 34. While only one document 11 is shown in FIG. 1, the slot 12 may be configured to accept documents of various sizes and shapes. The slot 12 may also be configured to accept multiple documents simultaneously.

The document 11 is inserted into the slot or opening 12. The slot 12 may accommodate both single-sided and double-sided scanning. The document 11 actuates the switch 13. The switch 13 may include devices to detect the presence of the document 11 (e.g., optical sensors). The switch 13 notifies the CPU 14 of the presence of the document 11. In response, the CPU 14 sends a signal to controller 15 that causes the device 16 to energize at least one illumination source The light from the illumination device 16 is reflected from the document 11. The optics 17 focus the reflected image onto the camera 18. The camera 18 has an operational frequency range that is able to image near- and far-IR and long- and short-wave UV. The optics 17 and camera 18 may include a charge coupled device (CCD) camera as discussed with reference to FIG. 2.

Exemplary illumination sources of the device 16 are described in detail in U.S. Pat. No. 6,269,169 B1 and U.S. Pat. No. 6,088,133, the entire disclosures of which are incorporated by reference herein. A brief description of such devices is included below.

The illumination sources 16 may include direct and indirect light sources. The term “indirect” light sources refers to light sources where the incident light travels a path different from the reflected light. The term “direct” light sources refers to light sources where the reflected light travels parallel to the incident light illuminating the document 11. At least one illumination source 16 may be utilized to illuminate the document 11. Additional illumination sources may be utilized to illuminate the document 11. The invention is not restricted to the types or numbers of illumination sources utilized.

Indirect light sources include, but are not limited to, indirect far infrared (IR) sources, long and short wave ultraviolet (UV) arrays of light emitting diodes (LEDs), and fluorescent light sources. The light from each of these indirect light sources may pass through a diffuser medium to help illuminate the document 11 with uniform lighting.

An indirect far IR illumination source makes some black inks made with carbon black visible. Other black inks are not visible under the indirect far IR illumination source, even though there is no difference to the unaided eye between black inks with or without carbon. The document 11 may be printed with the special carbon black based inks. When illuminated with the indirect far IR light source this printing will appear, while other printing does not appear.

The CPU 14 stores the digitized image made under illumination of an indirect far IR light source for the carbon black ink printing based on information stored in document classification profiles and anti-counterfeiting libraries. Information in alphanumeric text format and written using carbon based inks is located in fixed MRZ fields on some documents. MRZ information may include, but is not limited to, the name, birthday, sex, and place of birth of the person to whom the document has been issued, the type of document, the date of issuance and expiration of the document, the issuing authority, issue run, and serial number of the document. If the carbon black images are in the specified areas, whether they be alphanumeric text or certain patterns or images, they will indicate that the document 11 has not been altered and is not counterfeit.

An indirect long wave UV light source causes certain inks to fluoresce, so they appear in the image captured by the camera 18 using this light source. Other inks do not fluoresce and therefore are not visible to the camera 18. Similarly, an indirect short wave UV causes other, special inks to fluoresce, while all other printing is not detectable, including printing made with inks that fluoresce under long wave UV light. In addition, alphanumeric characters and symbols may be printed on the document 11 with inks that are not visible to the human eye, but which appear when illuminated with a UV light source. These symbols may be printed on the document paper or on the laminating material. From the document classification profiles and anti-counterfeiting libraries stored in the memory 20, the CPU 14 searches the digitized image for the symbols that appear when illuminated under these UV light sources.

A fluorescent light source provides a balanced white light and may be used to illuminate everything on the document 11. As a result, any photograph or picture on the document 11 is captured, in addition to other information on the document 11, including an MRZ including machine detectable devices such as a one-dimensional or two-dimensional bar code, magnetic stripe, an embedded micro-chip or an optical stripe.

Direct light sources include, but are not limited to, direct near IR and blue light. These direct light sources may travel through fiber optic cable from LEDs to emulate a point source of light and illuminate the document 11. Such illumination may be done coaxially with the path the reflected light travels to the camera 18 as described with reference to FIG. 2.

Direct near IR is an array of LEDs that are energized at different power levels and are pulsed on and off at different frequencies. Direct near IR is not significantly affected by normal scuffmarks and scratches, or fingerprints and dirt on the surface of a laminate. Blue light is generated by an array of blue LEDs and is specifically used to verify that 3M's retro-reflective Confirm® material, if used as the laminate, has not been tampered.

FIG. 2 shows the optics path utilized by the reader-verifier 10 for direct light sources, such as direct near IR and blue light illumination sources. Positioned in front of the optics 17 and the camera 18 is a beam splitter 26 that reflects about fifty percent and passes about fifty percent of light incident upon it from the light source 16. Alternatively, the beam splitter 26 may have a different division ratio, such as 70%-30% or 80%-20%. The direct light source is represented by the blocks marked lights 16.

Lights emitted by the direct light source 16, for example direct near IR and blue light, as described above, may pass through a fiber-optic cable 28 and be incident upon a diffuser plate 27, which may be a diffraction grating. The diffuser plate 27 causes light output from the fiber-optic cable 28 to be diffused to uniformly illuminate the document 11. The diffused light impinges on the beam splitter 26, which causes about fifty percent of the light to pass through the beam splitter 26 and be lost. The other about fifty percent of the light is reflected from the beam splitter 26 and substantially-uniformly illuminates the document 11.

The light reflected from the document 11 is an image of what is on the document 11, including its laminate, if present. The reflected light travels back to the beam splitter 26 parallel to the light rays incident upon the document 11. The reflected light impinging upon the beam splitter 26 is split. About fifty percent of the light is reflected toward diffuser the plate 27 and is lost, and about fifty percent passes through the beam splitter 26 and enters the optics 17 of the camera 18. As described above, the camera 18 digitizes the image for processing and the CPU 14 stores the digitized image in the memory 20.

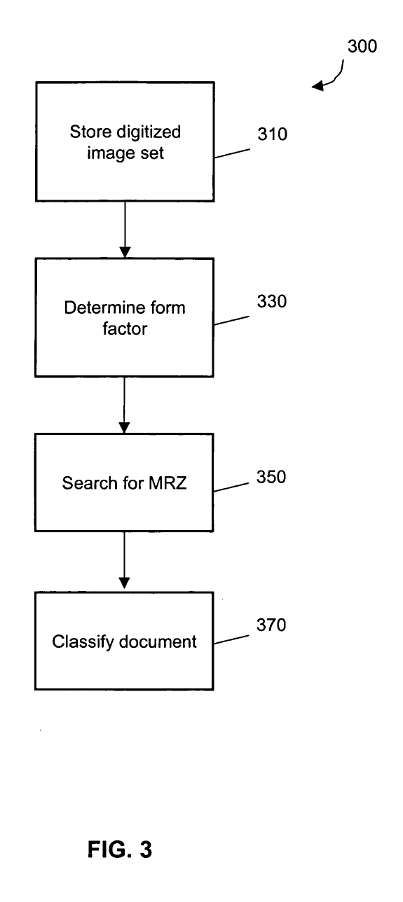

In operation, referring to FIG. 3, with further reference to FIG. 1, a process 300 to classify and authenticate the document 11 includes the stages shown. The process 300, however, is exemplary only and not limiting. The process 300 may be altered, e.g., by having stages added, removed, or rearranged.

At stage 310, the reader-verifier 10 scans the document 11 with an illumination source 16. The document may also be scanned with multiple illumination sources 16. The optics 17 direct the light to the camera 18. The A/D converter 19 transforms an analog scan result from the camera 18 into a digital input for the CPU 14. The scan result is stored as an image set in the memory 20. The image set may be obtained from a single illumination source or multiple illumination sources 16. The image set may include one or more than one image. Additional image sets may be created for the same document 11. Multiple image sets may be created if the slot 12 is configured to simultaneously allow scanning of multiple documents. The image sets may also be stored in a remote memory system through the network port 22.

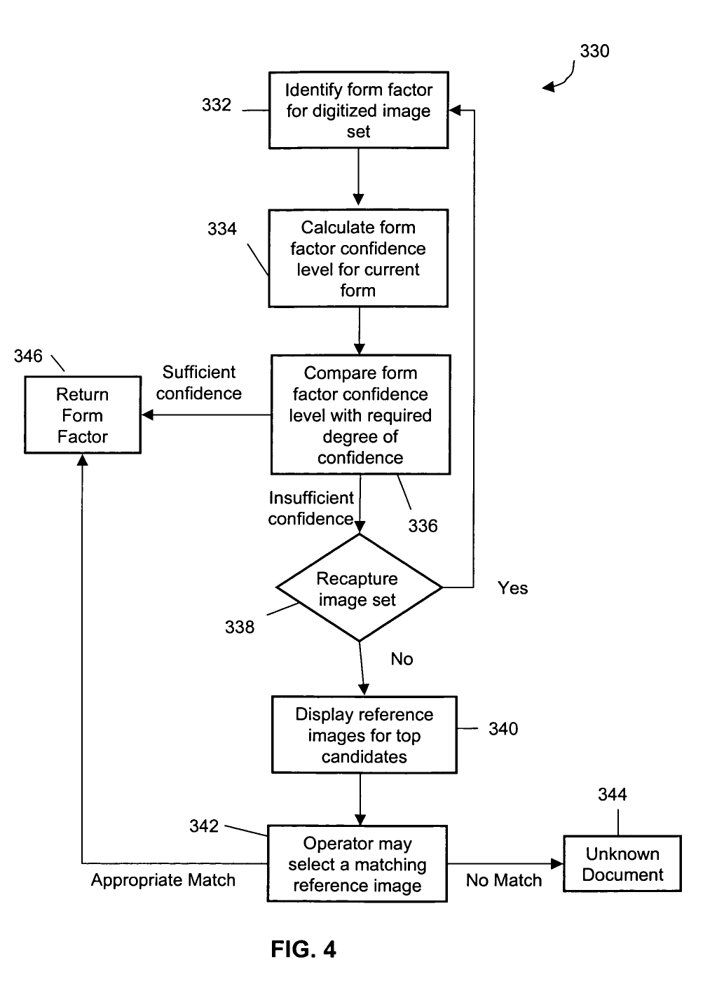

At stage 330, a form factor is determined for the document 11. The image set generated in stage 310 is/are compared to known document classification form factors. The image set(s) and document classification form factor(s) may be stored in the memory 20, or accessible through the network port 22. When a similar form factor is identified, a form factor confidence level is computed that is indicative of the confidence that the identified form factor is the appropriate form factor of the document 11. If the confidence level meets a required degree of confidence, the form factor is returned. If the confidence level does not meet the required degree of confidence, an operator is notified that the document 11 may not be authentic. Additional process stages for determining the form factor are discussed below with respect to FIG. 4.

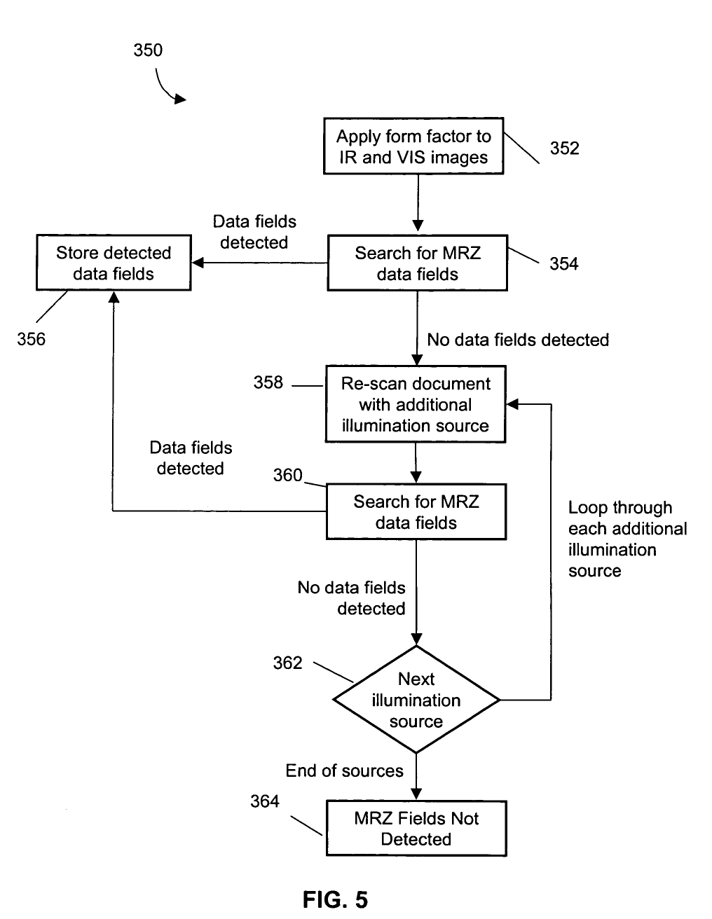

At stage 350, the reader-verifier 10 searches for MRZ data. The form factor returned from stage 330 is applied to the image sets. The form factor includes one or more indications of the location(s) of one or more MRZ data fields. The corresponding locations in the image sets are searched analyzed for MRZs. If the MRZ data fields are detected in the MRZ, the corresponding data is stored in the memory 20. If the MRZ data fields are not detected in the MRZ, the document 11 may be rescanned with a second illumination source 16. Both the content of the MRZ data fields, or the lack of data fields can be used to classify the document 11. Additional process stages for searching for MRZs are discussed below with respect to FIG. 5.

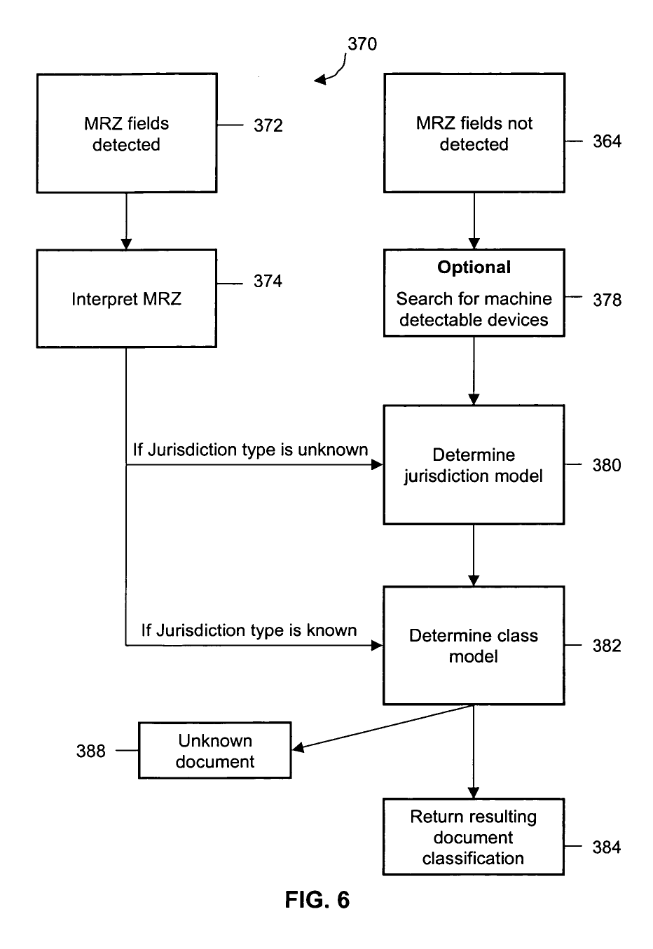

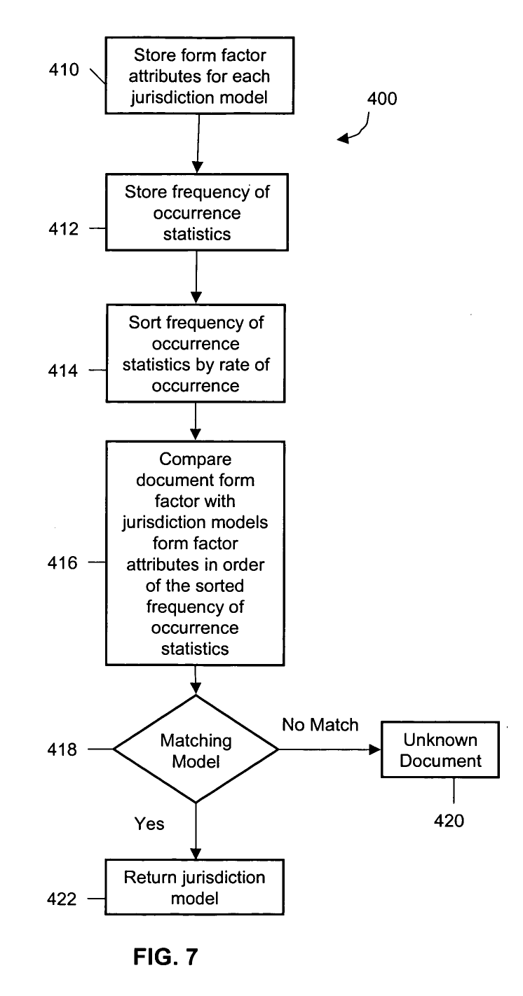

At stage 370, the document 11 is classified and authenticated. Document classification is preferably derived from the form factor determined in stage 330 and the result from the MRZ search in stage 350. After the document 11 is classified, an authentication process is initiated. Additional process stages are discussed below with respect to FIG. 6 and FIG. 7.

Referring to FIG. 4, with further reference to FIG. 1 and FIG. 3, the process 330 to determine a form factor includes the stages shown. The process 330, however, is exemplary only and not limiting. The process 330 may be altered, e.g., by having stages added, removed, or rearranged.

At stage 332, a form factor is identified for the image sets created for the document 11. The form factor can be identified manually (e.g., the operator making a selection via the display 24), automatically, or through a combination of both manual and automatic selection. The CPU 14 analyzes the stored image set against characteristics of a set of known document classification form factors to identify a form factor for the scanned document 11. The known document classification form factors data may persist in the memory 20, or may be accessible through the network port 22. The known document classification form factors data may include a variety of data formats (e.g. image and other binary files, proprietary database fields, and delimited text and XML files). Examples of known document classification form factors include passports, drivers licenses, and other identification documents. Additionally, document classification form factors may exist for commercial documents such as bonds, certificates, drafts, and other negotiable instruments and documents of value. The document classification form factor characteristics include, e.g., document size such as the sizes of the two dimensions (i.e., x and y axis) of a particular document, or the relative positions of text blocks and images within the particular document, etc. Relevant document classification form factors and/or characteristics may be added and removed from memory or the network as required for a particular document classification and authentication application.

At stage 334, a form factor confidence level is determined. The CPU 14 compares the form factor identified in stage 332 with the image set stored in memory 20 for the scanned document 11. The result of this comparison is the form factor confidence level. Various pattern recognition techniques and algorithms may be used to determine the form factor confidence level using the form factor characteristics. These characteristics, or pattern recognition variables, may include the height and width of a document, the presence of identification markers, the absolute or relative position of text blocks and photographic information, font styles and size, holographic tags, document color and texture, watermarks, optical bar codes, general and specific reflective indexes as functions of scan location and illumination source, OCR read rates, etc. The pattern recognition algorithm may modify the orientation or parse the image set based on a value of one or more of the variables listed above.

At stage 336, the form factor confidence level determined in stage 334 is compared to a required degree of confidence. The required degree of confidence is preferably a programmable variable that can be dynamically set for a multitude of equipment and operational variables. For example, the required degree of confidence can be a function of the document classification form factor (e.g., a passport may require a higher degree of confidence than a drivers license). Further, the degree of confidence level may be raised or lowered in support of terrorist threat conditions. The degree of confidence level may be adjusted based on statistical data generated by the reader-verifier 10 (e.g., self-regulating form factors based on the volume of passes and failures). If the value of the form factor confidence level is sufficient in light of the required degree of confidence, the selected form factor is the result of stage 330.

A form factor confidence level may not meet the required degree of confidence for several reasons. For example, the document 11 may not be authentic and therefore a matching document form factor does not exist. The document 11 may be damaged or worn resulting in a match with a low confidence factor. Document form factors may not exist for the document 11. The following process stages address these and other possible reasons that a form factor confidence level does not meet the required degree of confidence.

At stage 338, the document 11 may be scanned again. The re-scan action may be automatic or may be the result of an operator action. Prior to conducting a re-scan the operator may be notified to verify the orientation of the document 11. The operator may elect to re-scan the document 11. The re-scan action may result in a new image set or overwrite, or an augmentation of the previous image set. The previous image set may be stored in an archive file structure. The new image set may be displayed on the video screen 24 for operator review. The re-scanned image set may be used in stage 332 as described above.

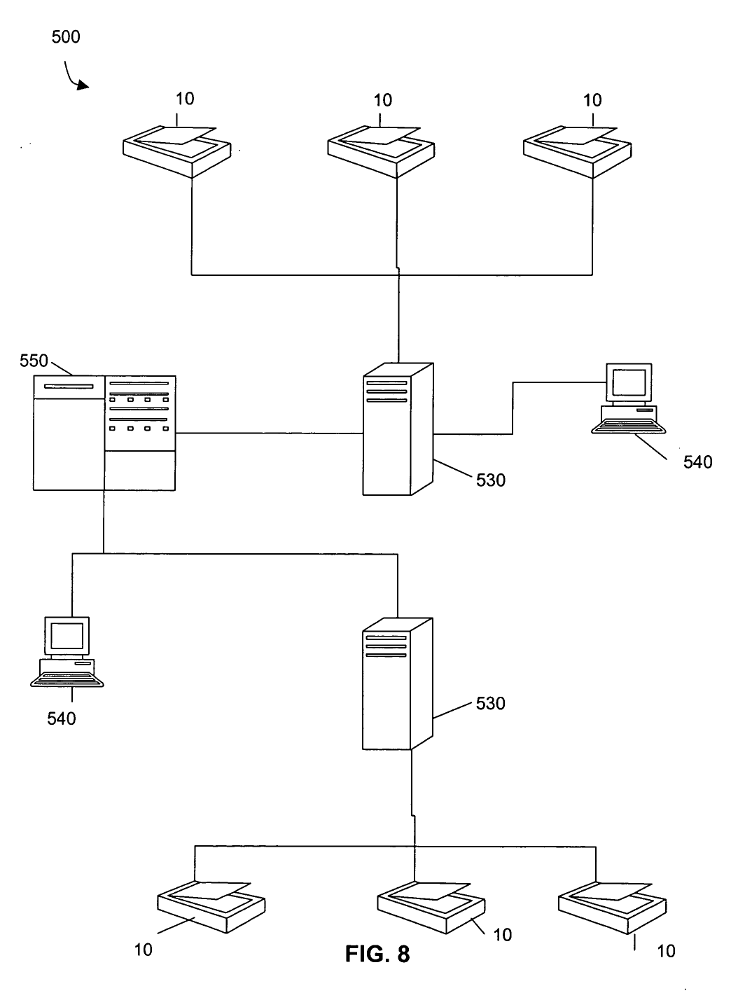

At stage 340, a list of possible known document form factors is produced and their corresponding reference images are presented to an operator. The known document form factors may exist in the memory 20 or may be accessible through the network port 22. A collection of known document form factors may persist on a local server or on a remote server accessible via a LAN/WAN and/or the Internet. The size and content of the collection of form factors may be modified to ensure timely processing at the location of the reader-verifier 10. The list of possible known document form factors is generated via a pattern recognition algorithm similar to stage 334. The resulting list of possible known document form factors is presented to the operator via a display screen or through the network port 22. The operator and video display can be remote from the reader-verifier 10. For example, as illustrated in FIG. 8, one operator at a terminal can review data for multiple reader-verifier units 10. The operator can simultaneously review the reference images associated with each of the possible known form factors and the image set generated for the document 11.

At stage 342, the operator can manually select a reference image that matches the image set generated for the scanned document 11. The resultant list from stage 340 is displayed to the operator. The operator may select an appropriate form factor from this list, or may manually search the collection of known document form factors for an appropriate match. The match may or may not be identical. Alternatively, the operator may determine that a match does not exist. If a match is located, the form factor is returned as indicated in stage 346. If a match does not exist, an unknown document event is raised in stage 344.

Referring to FIG. 5, with further reference to FIG. 1 and FIG. 3, a process 350 to search for MRZ data fields includes the stages shown. The process 350, however, is exemplary only and not limiting. The process 350 may be altered, e.g., by having stages added, removed, or rearranged.

At stage 352, the form factor determined in stage 330 is applied to an IR and Visible image set stored in stage 310. The form factor identifies one or more spatial areas within the IR and Visible image set that should contain machine readable data.

At stage 354, the image set data within spatial areas identified from the form factor as areas for MRZs is analyzed for machine readable data fields (e.g., OCR characters, optical bar codes, and other special characters). Additional MRZ data fields may include biometric data (e.g., a facial photograph or a finger print), color detection, pixel density and reflection indices. An MRZ data field may be located on the backside of the document 11 and scanned with another illumination source or detection device (e.g., a backside bar code reader or smart-chip). Other machine detectable devices may be considered as MRZs (e.g., holographic marks, laminate watermarks). If the MRZ fields are detected, the results of the MRZ search are stored in stage 356. If the MRZ data fields are not detected, additional scans with other illumination sources may be performed in accordance with stage 358.

At stage 356, the results of the MRZ search in stage 354 or stage 360 are stored. The results may include data fields such as country, document number, issue date, or other document identifying indicia. The results of the MRZ search may also include a pass-fail criterion to indicate the presence of a required MRZ data field. The type and content of the MRZ data fields are discussed below in stage 372.

At stage 358, the document may be re-scanned with additional illumination sources. For example, the lights 16 in the reader-verifier 10 further include long and short wave ultraviolet (UV) illumination sources. In this configuration, the initial image may be the result of IR and Visible light scans of the document 11. If the MRZ data fields are not detected as discussed in stage 354 above, the document 11 may be scanned again with either the long or the short UV light sources contained in the lights 16. This second scan may be initiated automatically or after input from an operator. For example, the second scan occurs after an initial attempt to identify MRZ fields fails. Also for example, the second scan may occur in sequence immediately after the initial IR/VIS scan and stored as a second image set. The second image set can be analyzed for MRZ data and/or for authentication details such as 3M's retro-reflective Confirm®D material discussed above. Other embodiments include various iterations of scanning sequence, illumination sources and image set analysis. The number of scans and illumination sources are not limited to a single light spectrum. Multiple scans with various wavelengths, incident angles and polarization orientations may also be used.

At stage 360, the second image set is analyzed for MRZ data as described above in stage 354. If the MRZ data is detected, the search results are stored as in stage 356. If MRZ data is not detected, the absence of results can be utilized in classifying and authenticating the document 11 as indicated in stage 364 on FIG. 6.

At stage 362, the reader-verifier 10 may be programmed to loop through multiple illumination sources in the lights 16. The type and scan order for the illumination sources is configurable for a particular reader-verifier system. For example, the reader-verifier 10 in a particular country may be configured to scan the particular country's passports and therefore first utilize the illumination sources appropriate for the passports. This flexibility in illumination configuration and scan order can increase overall document throughput because additional illumination sources are invoked as on a subset of scanned documents (e.g., when MRZ data fields on the document 11 are not detected), rather than on every document scanned.

Referring to FIG. 6, with further reference to FIG. 1 and FIG. 3, a process 370 to classify and authenticate the document 11 includes the stages shown. The process 370, however, is exemplary only and not limiting. The process 370 may be altered, e.g., by having stages added, removed, or rearranged.

At stage 372, the MRZ search results stored in stage 356 are analyzed for existing data fields. For example, the MRZ data fields are converted from image information to ASCII text. Also for example, biometric data such fingerprints are mapped and converted into points of interest lists (e.g., ridge endings, spur, dot, lakes, bifurcation and crossover points). Further, facial picture data can be converted to standard formats and compared with existing digital libraries.

At stage 374, the MRZ data fields are interpreted in their appropriate context. For example, an ASCII text field representing a country is compared to a list of country codes, or a document number is compared to an allowable document number format. Also for example, biometric data can be cross-indexed to other databases through the network port 22.

At stage 364, a lack of MRZ data fields is stored. A lack of MRZ data fields does not necessarily prohibit classifying the document 11. For example, as indicated in stage 378, the reader-verifier 11 can be configured to interpret machine detectable devices (e.g., magnetic stripes, holographic marks, embedded microcircuits, back-side bar codes). Also for example, the image form factor determined in stage 346 can be used as the basis to determine a jurisdiction model in stage 380.

At stage 380, a jurisdiction model is determined. For example, the document 11 may include MRZ data fields but the data fields do not indicate the jurisdiction type. For example, the document 11 may not contain MRZ data fields and therefore does not include the jurisdiction data type. In both of these examples, the document form factor determined in stage 346 can be used as the basis to determine the jurisdiction model. The process for determining the jurisdiction model is described in FIG. 7.

At stage 382, a series classification model is determined based on a matching jurisdiction model data and/or MRZ data fields. A collection of series classification models exists in memory 20, or are accessible through the network port 22. The series classification models may be stored in a collection of series model subdirectories. The jurisdiction model data and/or MRZ data fields may directly or indirectly indicate the appropriate series model subdirectory to search. If the matching series classification model is identified in the subdirectory search, a resulting document classification is returned in stage 384. For example, the ICAO has developed a standard classification series. If the MRZ data fields on the document 11 indicate that the document 11 conforms to an ICAO classification series, the ICAO subdirectory will be searched for the series classification model that matches the document 11.

In the event that a series classification document is not identified, or the jurisdiction model data and/or MRZ data fields conflict with one another, an unknown document event is raised in stage 388.

At stage 384, the document classification result is returned to stage 370. The classification result is the basis for the selection of appropriate document authentication tests. There are several techniques for authenticating a document based on a classification result known in the art (e.g., the authentication tests disclosed and claimed in U.S. Pat. No. 6,269,169 B1, the entire disclosure of which is incorporated here by reference.)

Referring to FIG. 7, with further reference to FIGS. 1, 3 and 6, a process 400 to determine a jurisdiction model of the document 11 includes the stages shown. The process 400, however, is exemplary only and not limiting. The process 400 may be altered, e.g., by having stages added, removed, or rearranged.

At stage 410, a form factor attribute is stored for each of the jurisdiction models. The form factor attribute is similar to the known document classifications form factor data discussed in stage 332. The jurisdiction models and corresponding form factor attributes may persist in the memory 20, or may be accessed through the network port 22. A data storage system can be configured to provide the fastest access to the most common jurisdiction models (e.g., memory configurations, database indices, disk drive location and configuration).

At stage 412, a frequency with which the jurisdiction models are accessed is calculated and stored. A frequency statistic can be a function of the number of times a particular jurisdiction model is accessed at a particular reader-verifier 10, or may be based on a larger group of networked reader-verifiers 10. For example, the frequency of occurrence statistics may be a based on data collected for an entire geographic location (e.g., an airport, a particular border crossing, a bank branch office). The frequency of occurrence statistics may be stored in the memory 22, or accessible through the network port 22.

At stage 414, a list of frequency of occurrence statistics is accessible/searchable, e.g., sorted, by rate of occurrence. The jurisdiction models with the highest frequency of occurrence are indexed at the beginning of the list. The frequency of occurrence statistics are dynamic and may change with time, and therefore, the list can be re-indexed or re-sorted appropriately. The rate at which the list is re-indexed or re-sorted may be based on operational and technological considerations (e.g., volume of documents, or the processing speed of a computer network). For example, installations with high speed computer processing equipment may re-index the list with every document scanned. In these or other installations, the index may be modified at regular intervals (e.g., daily, hourly).

At stage 416, the form factor computed for the document 11 is compared to the jurisdiction model form factor attributes. The comparison occurs model by model as indexed in stage 414. That is, the form factor attributes for the jurisdiction models with the highest frequency of occurrence are evaluated first. For example, the comparison is complete when the first match occurs. Also for example, the entire sorted list of jurisdiction models can be evaluated and multiple jurisdiction models that match may be identified.

At stage 418, a determination is made whether the document 11 form factor, as determined in stage 330, matches a particular jurisdiction model form factor attribute. If a match does not exist, an unknown document event is triggered in stage 420. If a single match, or multiple matches, is/are identified, the corresponding jurisdiction model or models are returned from stage 422 to stage 382.

Referring to FIG. 8, with further reference to FIG. 1, a networked reader-verifier solution 500 includes multiple (here six) reader-verifiers 10, a server 530, an input and display device 540, and a main computer 550. Each reader-verifier 10 is connected to the network via the network port 22. The server 530 can be configured to augment or replace the reader-verifier memory 20. Program and data files can be transferred between the server 530 to the reader-verifier 10. For example, the processing capabilities of the server 530 can be configured to replace or augment the CPU 14 in the reader-verifier 10. This type of remote processing configuration, also referred to as a “lite” option, can have a substantial cost impact in a large scale networked application.

The input and display device 540 may provide access to the server 550 as well as the reader-verifier 10. For example, the input and display device 540 are the monitor and keyboard connected to the server 530. Also for example, the input and display device 540 can be a personal computer connected to the network 500 via a standard network cable or wireless connection. The input and display device 540 can replace or augment the keyboard 23 and video 24 of the reader-verifier 10. The input and display device 540 can receive and issue commands to and from the reader-verifier 10 via the network. For example, a single operator at the input and display device 540 can supervise several reader-verifier units 10.

The servers 530 can be configured to communicate with a main computer 550 over a LAN or WAN. The main computer 550 can manage and configure the program and data files on the servers 530. The program and data files on each server 530 can be modified to improve the speed of search results. For example, the series, sub-series and jurisdiction model files can be stored and organized based on frequency of access (e.g., the data with highest frequency of access can be stored on a local server 530, while other data can be stored and accessed on a remote system 550).

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A method for classifying and authenticating a document, the method comprising:
capturing a first image set of the document;
attempting to determine a document type by comparing a first attribute of the image set to a second attribute stored in a first list of attributes for each of a plurality of different document types;
searching for a first machine readable zone on the document based on the document type;
determining a first value based on the first machine readable zone;
attempting to identify a document class for the document using the first value; and
initiating an authentication procedure for the identified document class.

2. The method of claim 1 wherein capturing the first image set comprises illuminating the document with a first illumination source, the method further comprising capturing a second image set by illuminating the document with the a second illumination source, wherein the first and second illumination sources have different characteristics, the method further comprising searching for a second machine readable zone on the document using the second image set.

3. The method of claim 2 wherein capturing the second image set occurs if the first value is undetermined.

4. The method of claim 2 further comprising capturing a third image set of the document by illuminating the document with a third illumination source, wherein characteristics of the third illumination source are different from the characteristics of the first and second illumination sources, the method further comprising searching for a third machine readable zone on the document using the third image set.

5. The method of claim 1 wherein the attempting to determine the document type comprises:
calculating a confidence factor, wherein the confidence factor is based on the first attribute of the first image set and the second attribute stored in a particular one of the first lists of attributes;
comparing the confidence factor to a threshold confidence; and
identifying a first document type associated with the particular one of the first lists of attributes if the confidence factor is greater than the threshold confidence, wherein the first document type is included in the plurality of different document types.

6. The method of claim 5 further comprising capturing a second image set of the document.

7. The method of claim 5 further comprising displaying a list of document types to an operator.

8. The method of claim 7 further comprising accepting an input from the operator, wherein the input is indicative of a second document type, wherein the second document type is included in the list of document types.

9. The method of claim 1 wherein the attempting to identify the document class comprises:
comparing the first attribute of the image set to a plurality of attributes associated with a collection of different document classes; and
selecting the document class from the collection different document classes if the first attribute of the image set corresponds to a particular attribute associated with the document class.

10. The method of claim 9 wherein the comparing further comprises searching sequentially from an attribute corresponding to a most frequently occurring document class to an attribute corresponding to a least frequently occurring document class.

11. The method of claim 9 further comprising attempting to identify a document subclass by:
comparing the attribute of the image set to a plurality of attributes associated with a collection of different document subclasses, wherein the collection of different document subclasses is associated with the document class; and
selecting the document subclass from the collection of different document classes if the attribute of the image set corresponds to a particular attribute associated with the document subclass.

12. The method of claim 9 further comprising attempting to identify a document subclass by:
comparing the first value to at least one of a respective plurality of attributes associated with a collection of different document subclasses, wherein the collection of different document subclasses is associated with the document class; and
selecting a document subclass from the collection of different document subclasses if the first value corresponds to a particular attribute associated with the document subclass.

13. The method of claim 1 wherein the attempting to identify the document class comprises:
searching the document for a machine detectable device including a magnetic stripe, a smart-chip, and an optical bar code;
evaluating the machine detectable device for a second value; and
selecting the document class for the document using the second value.

14. A computer program product for use with a document classification and authentication device, the computer program product residing on a computer-readable medium and comprising computer-readable instructions configured to cause a computer to:
store an image set of a document;
determine a form factor of the image set;
search for at least one machine readable zone in the image set based on the form factor;
classify the document using the machine readable zone; and
authenticate the document using a document class of the document.

15. The computer program product of claim 14 wherein the instructions configured to cause the computer to store an image set of the document cause the computer to activate a first illumination source.

16. The computer program product of claim 17 wherein the instructions configured to cause the computer to store an image set of a document are configured to cause the computer to activate the first illumination source and a second illumination source, wherein the first and second illumination sources have different illumination characteristics.

17. The computer program product of claim 14 wherein the instructions configured to cause the computer to determine a form factor are configured to cause the computer to compare at least one attribute of the image set to at least one attribute associated with a plurality of different document types.

18. The computer program product of claim 17 wherein the instructions configured to cause the computer to determine a form factor are configured to cause the computer to access the attributes through a network port.

19. The computer program product of claim 14 wherein the instructions configured to cause the computer to determine a form factor are configured to cause the computer to display a list of form factors to an operator.

20. The computer program product of claim 14 wherein the instructions configured to cause the computer to search for the at least one machine readable zone are configured to cause the computer to activate a third illumination source, wherein the third illumination source has third set of illumination characteristics.

21. The computer program product of claim 14 wherein the instructions configured to cause the computer to search for at least one machine readable zone are configured to cause the computer to interpret the at least one machine readable zone for a first value.

22. The computer program product of claim 21 wherein the instructions configured to cause the computer to classify the document are configured to cause the computer to determine a first document class using the first value.

23. The computer program product of claim 22 wherein the instructions configured to cause the computer to classify the document are configured to cause the computer to determine a second document class using the first value and the first document class.

24. The computer program product of claim 14 wherein the instructions configured to cause the computer to search for at least one machine readable zone are configured to cause the computer to interpret a machine detectable device for a second value, wherein the machine detectable device is at least one of a magnetic stripe, a smart-chip, and an optical bar code.

25. The computer program product of claim 24 wherein the instructions configured to cause the computer to classify the document are configured to cause the computer to determine a second document class using the second value.

26. The computer program product of claim 25 wherein the instructions configured to cause the computer to classify the document are configured to cause the computer to determine a third document class using the second data value and the second document class.

27. A system for classifying and authenticating a document, the system comprised of:
a plurality of illumination sources;
means for storing a digital image of the document illuminated by at least one of the illumination sources, for computing a plurality of document attributes from the digital image;
means for connecting to at least one database containing a plurality of document form factor records, for searching the at least one database for a first data field in the plurality of document form factor records, and for identifying a first document form factor based on a correlation between the first data field and a particular attribute in the plurality of document attributes;
means for interpreting the first document form factor to determine the location and content of at least one machine readable zone, for searching the at least one database for a second data field in a collection of document class records, and for selecting a first document class associated with a particular document class record based on a correlation between the content of the at least one machine readable zone and the second data field; and
means for initiating an authentication procedure based on the first document class.

28. The system of claim 27 further comprising means for selecting one or more of the plurality of illumination sources based on the document form factor.

29. The system of claim 27 further comprising means to sort and search the collection of document classes in order of a frequency of occurrence, wherein the frequency of occurrence is based on the number of times a particular document class is accessed over a period of time.

30. The system of claim 27 further comprising means for searching the at least one database for a third data field in the collection of document class records, and for selecting a second document class associated with a particular document class record based on a correlation between at least one of the plurality of document attributes from the digital image and the third data field.
